(19) United States
(12) Patent Application Publication
(10) Pub. No.: US 2005/0289628 A1
(43) Pub. Date: Dec. 29, 2005

(54) Digital repeater for data signals over a tree and branch network

(75) Inventors: Robert P. Basil, Lawrenceville, GA (US); Stephane Denis Jacques Chapeau, Duluth, GA (US)

Correspondence Address: ARRIS INTERNATIONAL, INC, 3871 LAKEFIELD DRIVE, SUWANEE, GA, 30024, US

(73) Assignee: coaXmedia, Inc., Duluth, GA (US)

(21) Appl. No.: 10/924,234

(22) Filed: Aug. 23, 2004

Related U.S. Application Data
(60) Provisional application No. 60/496,956, filed on Aug. 21, 2003.

(51) Int. Cl. H04N 7/173

(52) U.S. Cl. 725/111; 725/105

(57) ABSTRACT

A digital repeater for use in a tree and branch communication network is disclosed. The digital repeater has first path for downstream data communications. The first path does not perform Viterbi decoding in order to minimize the delay for downstream communications. A second path with a Viterbi decoder is used to detect communications addressed to the digital repeater. The disclosure includes other related material including teachings on the integration of the digital repeater into a network including modifications to polling, discovery, and automatic gain control procedures.

### PRIORITY APPLICATION

This application claims priority to Provisional Application Ser. No. 60/496,956 filed Aug. 21, 2003, the disclosure of which is incorporated by reference herein in its entirety, and to which priority is explicitly claimed herein to the filing date thereof.

### CROSS-REFERENCE TO RELATED APPLICATIONS

This application provides a network that can utilize inventive concepts disclosed in co-pending application U.S. Ser. No. 10/205,523 for Methods for Detecting and Polling Downstream Modems based on Provisional application 60/309,809 filed Aug. 3, 2001.

Another related co-pending application is Architecture and Method for Automated Distributed Gain Control for Internet Communications for MDUs and Hotels (U.S. Ser. No. 09/818,378 based on Provisional Application No. 60/193,855). The '855 application has the filing date of Mar. 30, 2000. The '378 application provides an overview of an early version of the solution offered by common assignee coaXmedia, Inc. coaXmedia, Inc. has a number of other co-pending applications describing various improvements and variations to the system set forth in the '378 application.

A third related co-pending application is U.S. Ser. No. 10/071,007 for Multi-Band Coax Extender for In-Building Digital Communication Systems based on (Provisional Application No. 60/267,046 with filing date Feb. 7, 2001).

Certain terms used by the applicant to define the operation of the inventive system are defined throughout the specification. For the convenience of the reader, applicant has added a number of topic headings to make the internal organization of this specification apparent and to facilitate location of certain discussions. These topic headings are merely convenient aids and not limitations on the text found within that particular topic.

### BACKGROUND

Technical Field

The present invention adds to the field of data communications. More particularly the invention is one of the ongoing improvements in the area of data communications addressing the use of shared transmission media such as passive coax distribution. The present invention provides a system and method to regenerate digital signals.

Problem Addressed

After a location receives CATV signals from the provider, the CATV signals are distributed throughout the facility by a coax tree and branch distribution network. Larger tree and branch networks often include in-line amplifiers (called line extenders) to overcome cable and passive component losses. In large MDU facilities with distant buildings, it is common to encounter network branches containing several of these in-line CATV amplifiers in series.

Signal distortion resulting from the cascade of multiple line extenders as well as other cable plant impairments frequently limits the range and throughput of digital services such as broadband Internet access.

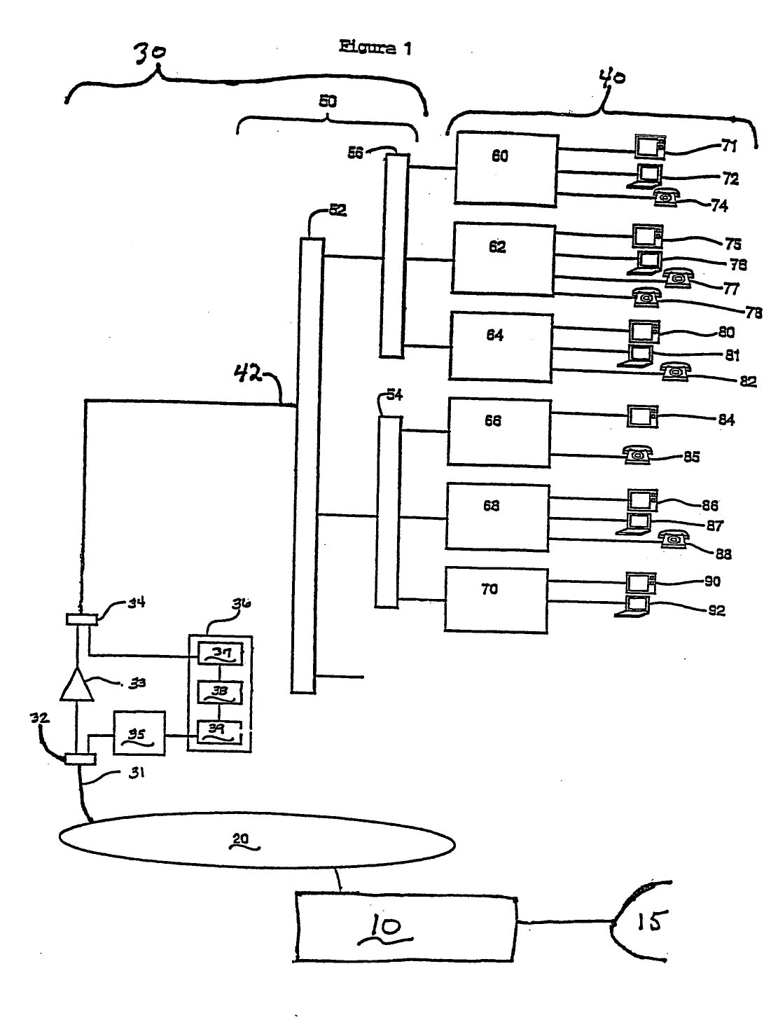

The innovative solution can be understood in the context of the primary product of assignee coaXmedia, Inc. In order to provide context to the present invention, the system described in the related applications is represented in FIG. 1. Although we focus hereafter on describing solutions to this problem in the context of coaXmedia's system, the concepts largely apply to other systems such as those involving traditional cable modems. Those of skill in the art can readily adopt the teachings of the present invention for use in these other systems.

FIG. 1.

The related applications describe a system that allows the connection of devices such as personal computers to special modems that connect to a legacy tree and branch coax network in a hotel, Multiple Dwelling Units (MDUs), or analogous building. The system described used two frequencies in a range above the range used for cable TV. Thus, the system would have one frequency for a downstream channel and one frequency for an upstream channel. As this is a tree and branch network, all communications heading downstream must identify which modem device (or devices) is being addressed since all modem devices in FIG. 1 will receive the communication. Conversely, the communication from the many individual modem devices to the upstream end of the network must be controlled so that only one modem device is sending an upstream communication at any one time in order to avoid bus contention. The method of control used in the referenced applications is based on polling and response model.

The situation addressed by both the '378 application and the current invention is shown generally in FIG. 1. FIG. 1 can be subdivided into four clusters of components. The first cluster is Cable-TV Headend equipment 10. The second cluster is the Hybrid Fiber-coax (HFC) Distribution Network 20. The third cluster is the premises coax distribution equipment 30 which could exist in either an MDU or an analogous situation such as a hotel. The final cluster is the cluster of equipment in the user's room 40. Clusters 30 and 40 contain elements of the present invention. In keeping with industry conventions, the Cable-TV Headend and the Internet are the upstream end of FIG. 1 for cable TV and IP data respectively. The television set or computer in the user's room are the downstream points. Upstream data transmissions travel upstream towards the upstream end. Downstream transmissions travel downstream towards the downstream end. Thus, a component on a data path receives a downstream data transmission from its upstream end and an upstream data transmission from its downstream end.

The contents of Cable-TV Headend equipment 10 is described in the referenced '378 application and does not need to be repeated here. In general, a cable TV signal is provided to the HFC distribution network 20. Digital communication signals from Internet 15 travel through Cable-TV Headend equipment 10 to the HFC Distribution Network 20. The description of selected elements of the Cable-TV Headend is to provide context for the present invention and does not constitute a limitation or required elements for the present invention.

In cluster 30, the incoming signal from the HFC Distribution Network 20 is carried on cable 31 to joiner device 32. The joiner device 32 is connected to the input of TV Channel Amplifier 33. The Output of TV Channel Amplifier 33 is passed to a second joiner device 34 and then to set of one or more joiner devices forming the tree and branch distribution network 50 terminating at a series of TV coax Receptacles (not shown). The technology for tree and branch networks suitable to distribute Cable TV signals is well known to those of skill in the art. Thus, in order to avoid unnecessary clutter, the tree and branch network 50 is shown with just a few joiner devices and connecting cables rather than the full set of components for a tree and branch network.

Joiner devices 32 and 34 form a bypass around the TV Channel Amp 33. This bypass loop has a cable modem 35 at the upstream end and data hub 36 (“hub”) (also called the “server”) at the downstream end of the bypass loop. As described in the '378 application referenced above, the server 36 is comprised of a number of components shown here as RF modem 37, protocol converter 38, and NIC unit 39. The operation of these components was described in the '378 application and does not need to be repeated here. A coax tree and branch network 50 connects the head end 42 of the tree and branch network to a set of splitter devices.

A partial set of splitter devices is shown in FIG. 1 as splitters 52, 54, and 56. Thus, the signal at head end 42 is present at the input to client modem devices 60, 62, 64, 66, 68, and 70. Output jacks on the client modem devices allow for connection of televisions (71, 75, 80, 84, 86, and 90), devices such as personal computers (72, 81, 87, and 92), and telephones (74, 77, 78, 82, 85, and 88). As the cable TV signal does not need to be processed within the modem devices, this signal can be taken from an external diplexer positioned upstream of the modem device rather than as shown from an output on the modem device. Note elements 94 and 96 will be discussed below.

The '378 application includes an RF coax transmission system in which all information flowing downstream (from 42 to the client modem devices 60, 62, 64, 66, 68, and 70) is formatted according to DVB/MPEG-2 structure to facilitate multimedia applications and to allow the system to use mass-produced DVB compliant devices

Problems with Multiple Serial Line Extenders

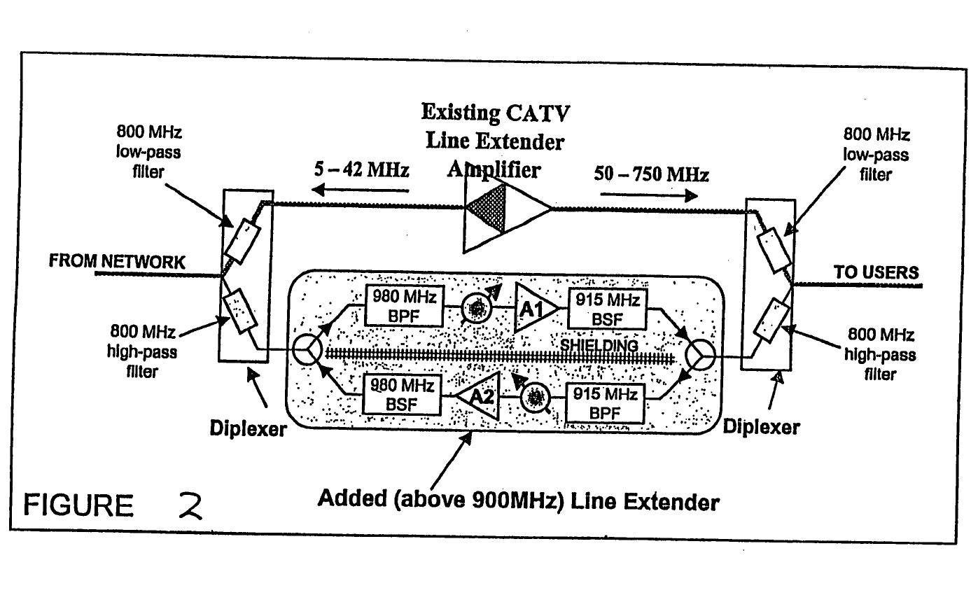

A bi-directional amplifier (line extender) developed by assignee to boost its upstream and downstream signals where needed is represented in FIG. 2.

When used in conjunction with power passing diplexers, such line extenders can be used to bypass the in-line CATV amplifiers. However, the signal distortion considerations discussed earlier limit the number of such cascaded systems to about three per branch. The line extender shown in FIG. 2 uses a combination of filters and diplexers to avoid unwanted RF feedback along the path between the input and output of the CATV amplifier. However, even with these measures to reduce adverse effects, there is a limit to the amount of gain that can be obtained from each line extender. Thus, the line extenders with their limited gain may be inadequate to compensate for the network losses at the frequencies of interest.

Problems with a Modem Server Pair as a Repeater Station

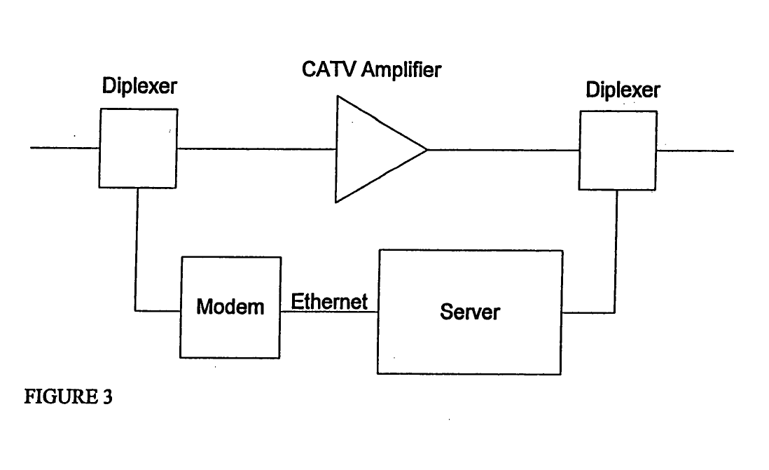

An alternative solution is shown in FIG. 3. FIG. 3 illustrates solution in which the CATV amplifier is bypassed by a client modem connected to a Broadband Gateway (Server) via the client modem's Ethernet port.

This configuration restores the digital signals to their original and virtually distortion free levels. This configuration also relaxes the diplexer isolation requirements since it removes the possible RF feedback path between the input and output of the CATV amplifier.

Although a modem/server pair solves the above-identified problems, it is not an optimal solution for several reasons. One reason is that a modem/server pair is a costly solution because it uses a full Broadband Gateway (Server). A second problem with the use of a modem/server pair is that it introduces undesirable delays (“latencies”) in the network as the data is demodulated, recreated, and re-modulated. A third disadvantage of using a modem/server pair is that the throughput though the modem/server pair is limited by the half duplex 10 base T Ethernet interface of the client modem. Thus, communications to the portion of the tree and branch network downstream of the modem/server pair is limited to half duplex 10 base T Ethernet interface of the modem. This is a real loss since the speed of the modem is often a small fraction of the output speed of the hub 36.

It is therefore an object of the present invention to provide for signal treatment to allow digital signals to be carried over extensive tree and branch networks.

It is a further object of the present invention to provide for signal treatment to allow digital signals to be carried over extensive tree and branch networks while avoiding the problems with latency, cost, and capacity bottlenecks associated with prior art solutions.

These and other advantages of the present invention are apparent from the drawings and the detailed description that follows.

### BRIEF SUMMARY OF DISCLOSURE

The novel solution to the problem set forth above is a digital repeater that is an improvement of the modem/server pair solution. However, unlike the prior art method shown in FIG. 3, the disclosed invention will not introduce significant latencies, will not limit the throughput in the branch of the network where it is installed, and will be more cost effective.

### DETAILED DESCRIPTION OF THE DISCLOSED EMBODIMENT

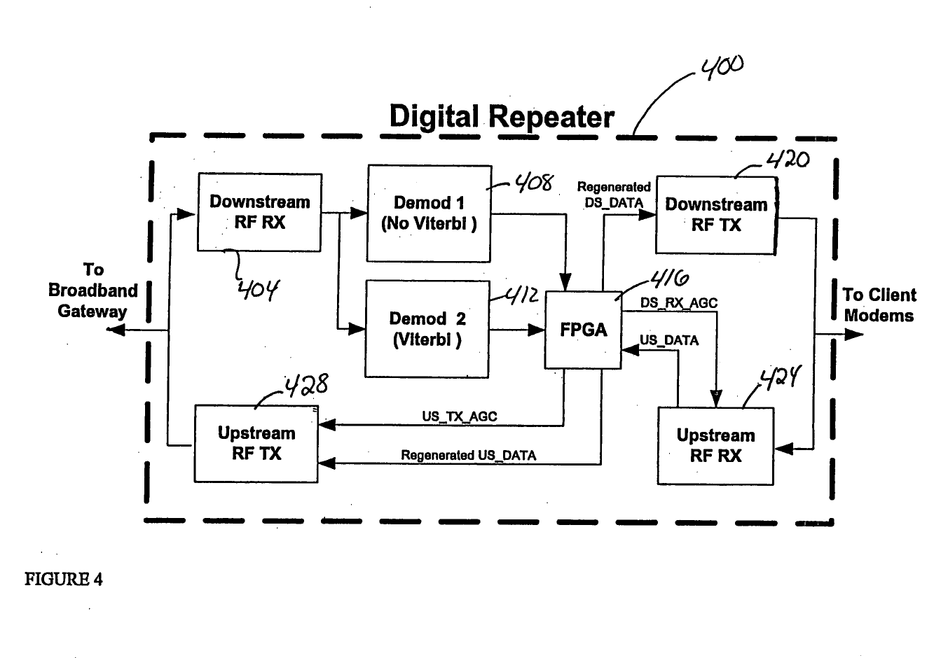

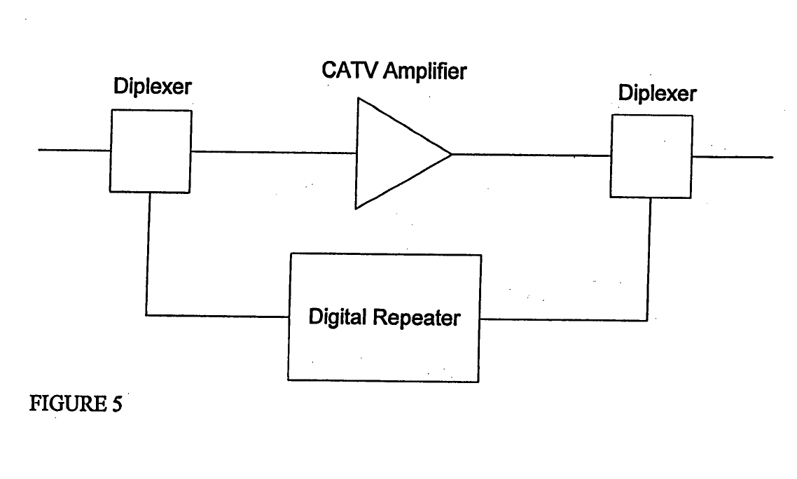

A preferred embodiment of the digital repeater's block diagram is shown below in FIG. 4. As shown in FIG. 5, the digital repeater would be placed in parallel with the CATV amplifier and connected by a pair of diplexers. Again, note that the power passing diplexer specifications can be relaxed since the RF feedback path is virtually inexistent.

Internal Operation of a Digital Repeater

Downstream Communications

Viterbi encoding is used for the downstream communications in keeping with the DVB standards. By way of background, Viterbi encoding uses convolutional encoding to encode the data before transmission. A convolutional encoder converts the transmitted data into a form requiring more bits per unit of information. This encoding makes it easier to discern one transmitted value from another. In order to use the data, a Viterbi decoder is used to decode the convolutionally encoded data. Unfortunately, Viterbi decoders need to evaluate a large number of node equations in order to decode the convolutional codes. Thus, the use of a Viterbi decoder adds a delay to any process using the encoded data.

The downstream data communication leaves the hub 36 convolutionally encoded. Functionally, the digital repeater receives the downstream data at block 404. The data is then demodulated with minimum delay without use of the Viterbi decoder in demodulator (408). At the FPGA 416, the bit stream values are discerned and digitally filtered in accordance with the DVB standards. The recovered bit stream is then, modulated onto the downstream carrier at block 420 by a transmitter line-up similar to that of the hub 36. This process restores the quality of the downstream signals.

The data output by demodulator 1 (408) is still convolutionally encoded since the Viterbi decoder was not used. Thus, the preferred embodiment of the present invention does not use the Viterbi decoder in order to minimize the delay for downstream communications heading downstream of the digital repeater. The Viterbi decoding and error detection will occur at the client modems but not at intermediate stops at digital repeaters.

Since the output of demodulator 1 is not decoded, the digital repeater 400 cannot read the contents of the communication. To make it possible that the digital repeater can read the downstream data, a second demodulator with its Viterbi decoder enabled must be added (demodulator 2 (412)). The output of demodulator 2 (412) opens a control channel between the hub 36 and the digital repeater 400. The ability of the hub to communicate to the digital repeater allows the digital repeater to have client modem like properties when seen from the hub 36. For example, the time delay introduced by demodulator 2 (412) causes the response by the digital repeater to a communication from the hub 36 to occur within the appropriate response time window. Thus, the digital repeater 400 responds to commands in a manner like the client modems.

Upstream Communications

Upstream communications are received and demodulated at 424. The burst demodulator of the upstream receiver introduces a negligible delay. In the preferred embodiment, Viterbi encoding is not used on upstream communications. Thus, Viterbi decoding is not required for upstream communications. The upstream communication may be modified as described below to carry automatic gain control information before being modulated and retransmitted at transmitter 428.

Interaction of Digital Repeaters with the Network.

As viewed by the Hub 36 the digital repeater behaves somewhat like a regular client modem. The digital repeater has a MAC ID. The digital modem can be discovered and polled in accordance with the teachings of the '809 application referenced above. In the preferred embodiment, no downstream data passes through an “undiscovered” digital repeater until the digital repeater has been discovered and its gain has been set. This is a safeguard to avoid the transmission of upstream communications from client modems downstream of an undiscovered digital repeater where such communications may be at intensities that are too low or too high.

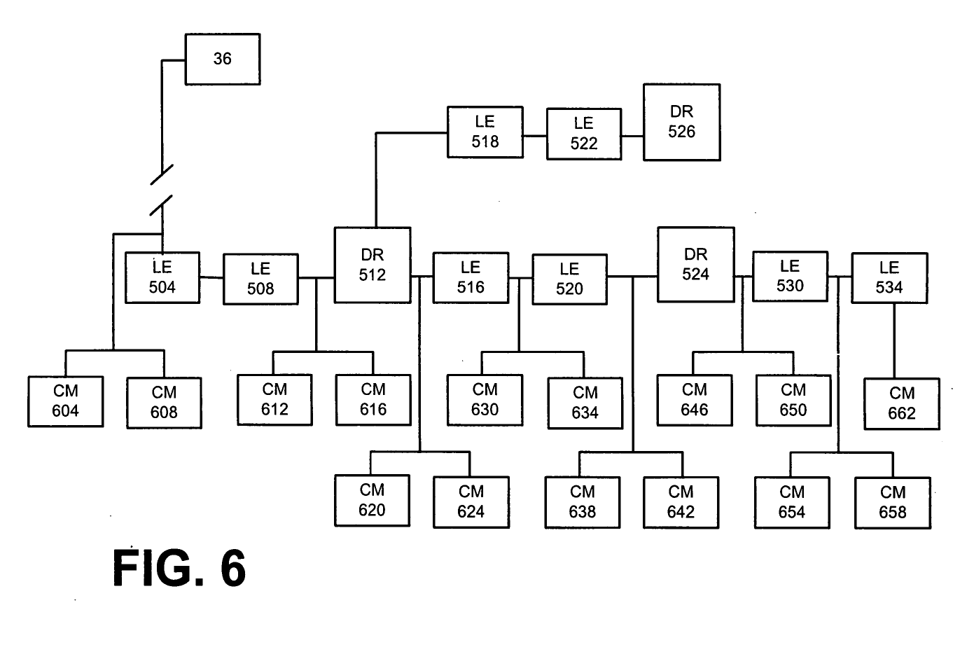

This modification can be better understood if described in connection with FIG. 6. Thus, after a digital repeater is discovered and its gain set for upstream communications, then the devices downstream of the newly discovered digital repeater become eligible for discovery. For example, client modem 662 would be subject to discovery and initial setting of its upstream gain, only after A) first, the digital repeater 512 had been discovered and set; and B) second, the digital repeater 524 had been discovered and set.

In a preferred embodiment of the digital repeater, the digital repeater can participate in a system to adjust the gain setting for the client modems and for the digital repeaters. In the '378 application, a method of adjusting the gain of the various client modems was set forth as follows:

Path losses between each client modem 60, 62, 64, 66, 68, and 70 and the central hub 36 will have a wide variation due to the coax distribution topology and loading variations. The system is designed to accept losses of 40 dB or more.

Loss variations in the downstream direction are compensated by an automatic gain control (“AGC”) function contained in each client modem receiver. The upstream AGC method involves adjusting each of the client modem transmitters such that their signals, upon arrival at the upstream receiver in the hub 36 are approximately equal.

Each time a data burst is sent to a client modem, an extra bit is included which indicates if the previous transmitted burst from that client modem was above or below the ideal level required at the receiver within the hub. This bit is used by the client modem to slightly adjust, either upward or downward, the level of its next transmitted burst. Thus, all signals received by the hub from every client modem become aligned in level and cycle upward and downward by a small amount. This is an ideal situation since the upstream receiver has a much wider acceptable input signal range than the small level variations received. Control systems of this type are fast to react to changes in transmission path attenuation and are intrinsically stable.

The present invention modifies the Automatic Gain Control strategy disclosed in the '378 application. This modification can be better understood if described in connection with FIG. 6. In order to avoid undue clutter, the cable TV line extenders and the televisions sets are not shown in FIG. 6. Unlike FIG. 6, a real network is likely to have many more than one or two client modems connected to the various links in the network.

FIG. 6 shows a very large distribution network that is connected indirectly to hub 36. Because of the losses referenced above, the network of FIG. 6 uses a combination of line extenders (504, 508, 516, 520, 530, and 534) and digital repeaters (512 and 524). Although a network could be created using digital repeaters and without any line extenders, this solution would be more expensive than a mix of line extenders and digital repeaters.

The automatic gain control for upstream communications will be unchanged for client modems 604, 608, 612, and 616. The operation of automatic gain control for client modems 646, 650, 654, 658 and 662 would be as follows. When an upstream communication from one of these modems (654) is received at digital repeater 524, the digital repeater 524 looks at a bit in the upstream message reserved for the automatic gain control signal. If this bit is unset, then the digital repeater 524 compares the strength of the signal as received at the digital repeater 524 and sets the automatic gain control bit to indicate if the received strength was high or low (optionally, it could have high/low/OK or some other more granulated system). Rather than communicating this gain control back to the client modem, the upstream message from the client modem is re-modulated on the upstream channel by transmitter circuits similar to those used by the client modems. The restored upstream communication passes through line extender 520 and 516 before receipt at digital repeater 512. At digital repeater 512, the automatic gain control bit is checked to see if this message came from a modem downstream of digital repeater 524 or was from local client modems (620, 624, 630, 634, 638, or 642). In this case, the automatic gain control has been set by digital repeater 524, so the automatic gain control bit is not adjusted in digital repeater 512. The upstream data communication is again re-modulated on the upstream channel by transmitter circuits similar to those used by the client modems.

The upstream communication from client modem 654 thus continues upstream until it is eventually received by hub 36. When hub 36 sends its next message to client modem 654, the message will provide any needed feedback for client modem 654 to adjust its output gain to provide a signal to digital repeater 524 that is closer to the target signal strength.

After the initial upstream gain for the digital repeater is set upon discovery, the one embodiment calls for the automatic gain control for the digital repeater 512 to be further adjusted by polling messages sent directly to the digital repeater 512. Identical to client polling, this digital repeater polling contains a gain control bit to provide feedback that indicates that the signal from the digital repeater 512 to the hub 36 is above, below, or equal to the ideal signal strength.

Note however that the digital repeater generally does not have upstream data when polled. The purpose of the polls is mainly for AGC adjustment and thus the polls can be very infrequent and consume very little bandwidth. Exceptions to this general rule would include administrative functions such as checking what revision of software is being used by the digital repeater or checking the current automatic gain control setting for a digital repeater. These administrative actions are implementation specific and not relevant for purposes of the present invention.

From a system point of view (FIG. 6), the digital repeater is virtually transparent to downstream and upstream traffic. Client modems located downstream from a digital repeater are polled for upstream data by the hub in the same way as any other client modem in the network. This is a key distinction with the prior art solution of a modem server pair as illustrated in FIG. 3.

Those skilled in the art will recognize that the methods and apparatus of the present invention has many applications and that the present invention is not limited to the specific examples given to promote understanding of the present invention. Moreover, the scope of the present invention covers the range of variations, modifications, and substitutes for the system components described herein, as would be known to those of skill in the art.

1. A method for providing two-way data communication for use in a system comprising:
a. at least one central modem;
b. a set of client modems; and
c. at least one digital repeater;
The method comprising:
A) the central modem sending downstream information, destined for at least one client modem, through the digital repeater;
B) the digital repeater receiving the information;
C) the digital repeater regenerating the received downstream information;
D) the digital repeater then sending the regenerated downstream information towards at least one client modems;
E) the client modem sending upstream information, destined for the central modem, through the digital repeater;
F) the digital repeater receiving the upstream information;
G) the digital repeater regenerating the received upstream information; and
H) the digital repeater sending the regenerated upstream information towards the central modem.

2. The method of claim 1 wherein the regenerated downstream information sent by the digital repeater is received by a second digital repeater which regenerates the downstream information before sending the regenerated digital information towards at least one client modem.

3. The method of claim 1 wherein the digital repeater regenerates the downstream data without decoding the downstream data forward error correction.

4. The method of claim 1 wherein the step of the digital repeater regenerating the received downstream data is performed without decoding the downstream data forward error correction and comprises an additional step of routing a copy of the received downstream data to a second slow path that includes decoding a copy of the downstream data for use within the digital repeater as the digital repeater is an addressable component that can receive instructions directed to a set of at least one component including that particular digital repeater.

5. The method of claim 1 wherein the digital repeater has a fast path that does not decode the downstream data forward error correction before passing the regenerated downstream data to the at least one client modem.

6. The method of claim 1 wherein the digital repeater has a fast path that does not decode the downstream data forward error correction before passing the regenerated downstream data to a second digital repeater.

7. The method of claim 1 wherein the power levels used by a client modem in sending upstream data to a digital repeater can de dynamically controlled by adding information to the upstream data in the digital repeater and having an instruction sent to that particular client modem in a subsequent communication from the central modem.

8. The method of claim 1 wherein the digital repeater can learn the addresses of the client modems downstream from the digital repeater.

9. The method of claim 1 wherein the digital repeater can learn the addresses of the digital repeaters downstream from the digital repeater.

10. The method of claim 1 wherein the digital repeater uses a portion of the downstream information coming from the central modem to a particular digital repeater to decrease the strength of a subsequent transmission from that particular digital repeater to that central modem.
